(19) United States
(12) Patent Application Publication
(10) Pub. No.: US 2017/0370835 A1
(43) Pub. Date: Dec. 28, 2017

(54) OPTICAL DETECTOR OF A VALUE OF AN ATMOSPHERIC PHYSICAL QUANTITY REPRESENTATIVE OF A DANGER

(71) Applicant: FINSECUR, Nanterre (FR)

(72) Inventors: Stephane DI MARCO, Nanterre (FR); Jacques LEWINER, Saint-Cloud (FR); Laurent PICHARD, Nanterre (FR)

(21) Appl. No.: 15/538,700

(22) PCT Filed: Dec. 22, 2015
(86) PCT No.: PCT/FR2015/053726

§ 371 Date: Jun. 22, 2017

(30) Foreign Application Priority Data
Dec. 22, 2014 (FR) 1463172

(51) Int. Cl. G01N 21/47; G01N 21/53; G08B 17/107; G08B 17/113

(52) U.S. Cl. CPC G01N 21/474; G08B 17/113; G01N 21/53; G08B 17/107; G01N 2021/4742

(57) ABSTRACT

The optical detector of a value of an atmospheric physical quantity representative of a danger includes:
a measurement chamber accessible to the atmosphere;
an electronics compartment for receiving electronics for detecting the value of the atmospheric physical quantity representative of a danger, the detecting electronics including electronic elements comprising at least:
   a light emitter,
   a light receiver that is sensitive to at least some of the wavelengths of the light rays emitted by the emitter, and
   electronics for processing detection signals,
      the detector in addition including:
a first light guide facing the emitter in order to direct the light emitted by the emitter from the electronics compartment to a detecting zone in the measurement chamber; and
a second light guide facing the receiver in order to direct light originating from said detecting zone to the electronics compartment in order to be received by the receiver, the amount of light received by the receiver being representative of the presence/absence in the detecting zone of said physical-quantity value representative of a danger.

The electronics compartment is separated from the measurement chamber, and isolates all of the electronic elements that it contains from the atmosphere and the light guides are arranged to penetrate the electronics compartment in a way that is seal-tight to the atmosphere.

### TECHNICAL FIELD OF THE INVENTION

The present invention relates to an optical detector of a value of an atmospheric physical quantity representative of a danger, and an alarm device comprising same. It applies, in particular, to the detection of flammable gases, smoke, aerosols or dust in residential, industrial, commercial or recreational public or private works structures and buildings.

### STATE OF THE ART

“ATEX” zones are zones in which there is a risk of an explosive atmosphere. These zones are the subject of a regulation known as “ATEX”. The purpose of this regulation is to control the risks relating to explosion in these atmospheres. There are several sub-divisions in the classifications of these zones: “0”, “1” and “2” for gases, “20”, “21” and “22” for dust. For each of these zones, regulations impose the use of specific materials to eliminate the risks of explosion.

In general, an ATEX product must be designed to avoid heating and sparks in contact with the explosive atmosphere.

Smoke detectors use several physical principles, and mainly the ionization of gases and optical scattering or absorption. In such detectors, the atmosphere must be allowed to enter inside a measurement chamber, since it is the particles present in this atmosphere that are to be detected. This constraint makes ATEX smoke detectors very difficult to design.

In the case of ionic smoke detectors, for example, the measurement chambers comprise electrodes designed to create an electric field for driving ions. These electrodes and the associated electrical circuits are therefore in direct contact with the atmosphere and therefore with the flammable gases that may possibly be there.

Optical smoke detectors are separated into scattering-based detectors and absorption-based detectors.

The principle of an optical scattering-based smoke detector is based on utilizing, firstly, an emitter of light rays and, secondly, a receiver of light signals scattered by the ambient air, the receiver being outside the field lit by the emitter. When there is no smoke in the air entering the detector, the receiver only receives a very small amount of scattered light. In contrast, when there is smoke in the air entering the detector, this smoke scatters the light originating from the emitter and thus lights the receiver.

In these optical detectors, light-emitting diode or laser diode emission circuits, for example, are associated with phototransistor or photodiode types of light receivers. Here again, electrical and electronic circuits are in contact with the atmosphere and therefore with any flammable gases that may possibly be there.

In optical absorption-based smoke detectors, an emitter of light rays and a receiver are used, both elements being arranged such that the receiver can receive the rays emitted by the emitter, either directly or after being reflected onto at least one reflector. The presence of smoke on the path of the beam has the effect of reducing the light signal received by the receiver. Here again, electrical and electronic circuits are in contact with the atmosphere and therefore with any flammable gases that may possibly be there.

### SUBJECT OF THE INVENTION

The aim of the present invention is to enable the production of smoke, aerosol, dust or gas detectors that can operate in an explosive atmosphere.

To this end, according to a first aspect, the present invention envisages an optical detector of a value of an atmospheric physical quantity representative of a danger, the detector comprising:
at least one measurement chamber accessible to the atmosphere; and
at least one electronics compartment for receiving an electronic device for detecting the value of the atmospheric physical quantity representative of a danger, the electronic detection device comprising at least
   one light emitter;
   one light receiver that is sensitive to at least one portion of the wavelengths of the light rays emitted by the emitter; and
   electronics for processing detection signals;
      the detector also comprising:
a first light guide facing the emitter in order to direct the light emitted by the emitter from the electronics compartment comprising said emitter to a detecting zone in a measurement chamber; and
a second light guide facing the light receiver of said electronics compartment, in order to direct light originating from said detecting zone to the electronics compartment in order to be received by the receiver, the amount of light received by the receiver being representative of the value of the physical-quantity representative of a danger;
   wherein the electronics compartment is separated from the measurement chamber and isolates all the electronic elements it contains from the atmosphere; and the light guides are arranged to enter the electronics compartment in a way that is seal-tight to the atmosphere.

The physical-quantity representative of a danger can be measured by optical means. For example, this physical quantity is a level of particles in the air or a presence of gas detectable by spectroscopy.

Therefore, it is possible to benefit from optical smoke detection in the measurement chamber, this chamber being open to the atmosphere but not containing any electrical circuit likely to present a risk with regard to the ATEX regulations and having the electrical and electronic portion of the detector completely isolated from the atmosphere.

In some embodiments, for at least one electronic device, the first and second light guides consist of a single part comprising a link resistant to the passage of the light from the first light guide to the second light guide.

In some embodiments, the link resistant to the passage of the light bears a centering stud.

Thanks to these provisions, the positioning of the single part comprising the prisms is reproducible and precise. Therefore, positioning the light emitter and receiver components is performed at the same time. It is therefore simplified and the reproducibility of the electronic smoke detection circuit's sensitivity is improved. Reproducibility of the emission/reception angles of the light rays is also improved. The production of light reflectors is made easier since they can be molded at the same time as the link connecting them. In effect, the inventor has determined that one problem with optical scattering-based detectors concerns the detection of faults and in particular the absence of emission by the light emitter component and/or where there is a loss of sensitivity in a light receiver component. However, these faults are critical since they limit, even prevent, the detection of smoke.

In some embodiments, said link comprises an optical guide designed to carry a portion of the light emitted by the emitter to the receiver, the electronic smoke detection unit being designed to detect the absence of reception, by said receiver, of said portion of the light emitted by the emitter, and to emit a signal representative of this absence of reception.

Thanks to these provisions, a very small portion of the light emitted by the emitter arrives continuously at the receiver. When it is detected that the receiver is no longer emitting a signal representative of this portion or is emitting an attenuated signal, the electronic unit signals a detector fault or malfunction. The portion of the light that arrives continuously is calibrated to always be lower than the level of light required for detecting smoke so that this permanent portion does not disrupt the detection of smoke.

In some embodiments, the link resistant to the passage of the light is a split optical guide, a portion of the split optical guide emerging at the exterior of the optical detector in a way that is seal-tight to the atmosphere.

Thanks to these provisions, it is possible to:
check the operation of the emitter component by positioning an external receiver component, for example in a movable casing that can be positioned opposite the place where said optical guide emerges;
especially in the case where the emitter component is likely to emit in the visible spectrum, communicate at least one item of information to the outside such as, for example, to signal a detection of smoke or a failure of the smoke detector circuit; and/or
communicate with the smoke detection circuit through the emission, for example via a remote control, of a light signal to the place where said optical guide emerges.

In some embodiments, the link resistant to the passage of the light is an optical guide forming a chicane, one optical guide comprising a zone absorbing light in the wavelengths of the light rays emitted by the emitter and/or one optical guide comprising a zone reflecting light in the wavelengths of the light rays emitted by the emitter.

Thanks to these provisions, the risks of parasitic lighting of the receiver via the optical fiber are reduced.

In some embodiments, the electronics compartment isolates all the electronic elements from the atmosphere by a seal-tight casing.

In some embodiments, for at least one light guide, there is at least one O-ring to connect said light guide to the electronics compartment at the point where said light guide enters the electronics compartment.

In this way, seal-tightness is ensured around the light guides when they enter the electronics compartment.

In some embodiments, the electronics compartment isolates all the electronic elements from the atmosphere by coating all the electronic elements it contains with an electrically insulating resin.

In some embodiments, seal-tightness is ensured by directly molding light guides in a resin for encapsulating the electronic elements and metal parts of the electronics compartment.

In some embodiments, the end of at least one of the light guides is buried in the resin.

In some embodiments, at least one light guide is surrounded by a sleeve whose refractive index is lower than the refractive index of said light guide.

In this way, a light ray that enters the light guide at a suitable angle undergoes multiple internal reflections. Thus, if the material forming the core of the light guide is not too absorbent for the light transmitted, the light that enters at one end of the light guide is almost entirely retrieved at the other end of the light guide.

In some embodiments, at least one light guide is surrounded by a light-reflecting layer.

In some embodiments, at least one emitter emits light rays with wavelengths in the infrared spectrum, and each light guide comprises at least one portion made of silica or polycarbonate.

Each light guide can be comprised of a material that absorbs little of the wavelengths transmitted. For example, in an embodiment the light emitter is arranged to emit light rays with wavelengths in the infrared spectrum, and each light guide contains at least silica.

In another embodiment, each light guide is made of a plastic material, easy to mold or inject. It is advantageous for this material to have two specific properties: good transmission in the infrared and limited retraction during demolding of molded parts. Polycarbonate is one of these materials.

Because of its sensitivity in the infrared, the receiver is not very sensitive to the ambient light, in the visible spectrum, which reduces the risks of a false alarm and the transmission of light rays is facilitated in each waveguide.

In some embodiments, said value of the physical-quantity in the detecting zone corresponds to the scattering of the light emitted by the emitter to the receiver.

In some embodiments, said value of the physical-quantity in the detecting zone corresponds to the reduction, by absorption, of the light directed from the emitter to the receiver.

In some embodiments, the detector comprises at least one reflector for reflecting the light originating from the first light guide, in the measurement chamber, to the second light guide.

In some embodiments, the first light reflector comprises a convergent reflector arranged to focus the light in the detecting zone, and/or the second light reflector comprises a convergent reflector arranged to focus the light originating from the detecting zone onto the receiver.

Thanks to these provisions, the detecting zone, where the light rays pass through any smoke to be detected, is smaller, which reduces the risks of parasitic reflection and the noise level.

In some embodiments, the detector also comprises:
a casing for housing the measurement chamber and arranged to allow air to pass while minimizing the introduction of parasitic light into said measurement chamber; and
an intermediate mount placed in the casing, equipped with an optical wall arranged to prevent the light emitted by the light guide located on the emitter side from reaching the light guide located on the receiver side.

In some embodiments, at least one of the light guides has one end placed in the measurement chamber and comprising a cylindrical portion extending up to and including the traversal of the seal-tight casing.

In some embodiments, the end positioned in the measurement chamber has the shape of a lens enabling the light beam that comes from it to be shaped.

This lens makes it possible to shape the light beam that comes from the measurement chamber.

In some embodiments, the end positioned in the measurement chamber has the shape of an optical prism.

In some embodiments, the detector also comprises a reflector for the light waves emitted by a first light guide, this reflector being positioned to send said light beam back to a second light guide.

In some embodiments, the measurement chamber consists of the premises to be monitored, the optical detector being placed in the vicinity of a first extremity of the premises, the light beam emitted through the first light guide traversing said premises, the reflector being placed in the vicinity of the opposite extremity of said premises, and being positioned to send said light beam back to the second light guide.

According to a second aspect, the present invention envisages an alarm device comprising at least one optical detector that is the subject of the present invention, and an emitter of alarm signals, where the emission of alarm signals is representative of the detection by an optical detector of a value of the physical quantity representative of a danger.

As the features, advantages and aims of this alarm device are similar to those of the detector that is the subject of the present invention, they are not repeated here.

### BRIEF DESCRIPTION OF THE FIGURES

Other advantages, aims and characteristics of the present invention will become apparent from the description that will follow, made as an example that is in no way limiting, with reference to the drawings included in an appendix, in which:

FIG. 1 represents, schematically and in cross-section, an optical detector according to a first embodiment of the present invention;

FIG. 2 represents, schematically and in cross-section, an optical detector according to a second embodiment of the present invention;

FIG. 3 represents, schematically and in cross-section, an optical detector according to a third embodiment of the present invention;

FIG. 4 represents, schematically and in cross-section, an alarm system according to an embodiment of the invention; and

FIGS. 5 to 10 represent schematically, fully or partially, embodiments of an optical detector that is the subject of the present invention.

### DESCRIPTION OF EXAMPLES OF REALIZATION OF THE INVENTION

For reasons of clarity, the figures are not to scale.

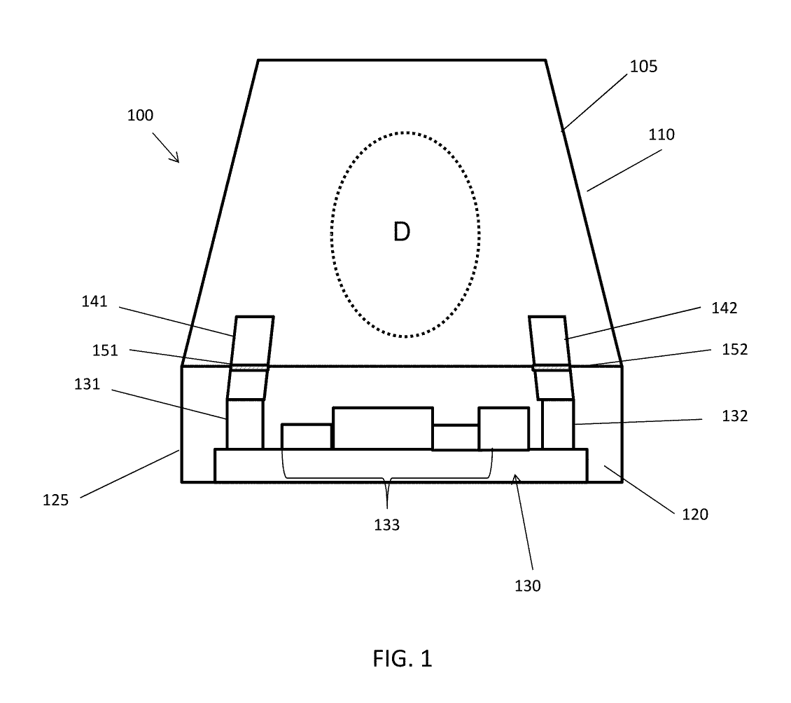

An optical detector of a value of an atmospheric physical quantity representative of a danger according to a first embodiment is represented schematically in FIG. 1. In this embodiment, the optical detector is configured to detect the presence of smoke in the atmosphere around the detector, the value of the physical quantity representative of a danger being the amount or level of smoke particles or aerosols, associated to a fire, in the atmosphere.

FIG. 1 shows an optical detector 100 according to the first embodiment comprising, in a casing 105, a measurement chamber 110 accessible to the atmosphere, and an electronics compartment 120 for receiving an electronic smoke detection unit 130. The electronic smoke detection unit 130 comprises a light emitter 131, a light receiver 132 that is sensitive to at least one portion of the wavelengths of the light rays emitted by the emitter 131, and electronics for processing detection signals 133.

In a particular embodiment, the casing 105 has openings in chicanes to allow the atmosphere in the measurement chamber 110 to pass through a detecting zone D while minimizing the penetration of ambient light into the detecting zone D. The internal walls of the casing 105 can be arranged to reflect the light rays as little as possible.

The optical smoke detector 100 also comprises:
a first light guide 141 facing the emitter 131 in order to direct the light emitted by the emitter 131 from the electronics compartment 120 to the detecting zone D in the measurement chamber 110; and
a second light guide 142 facing the receiver 132 in order to direct light originating from said detecting zone D to the electronics compartment 120 in order to be received by the receiver 132.

In this embodiment, the amount of light received by the receiver 132 is representative of the presence/absence of smoke particles in the detecting zone D.

Each light guide 141 and 142 can consist of a material that absorbs little of the wavelengths transmitted. For example, in this embodiment, the light emitter 131 is arranged to emit light rays with wavelengths in the infrared spectrum, and each light guide 141 and 142 consists at least of silica. Other materials may be suitable, for example plastic materials, easy to mold or inject, such as polycarbonate. Such a material, such as many amorphous polymers, exhibits limited retraction during demolding of molded parts.

The light emitter component 131 is, for example, a light-emitting diode operating in the infrared spectrum. The light receiver component 132 is, for example, a photodiode or phototransistor operating in the infrared spectrum.

The electronics compartment 120 comprises a seal-tight casing 125 configured to isolate all the electronic elements of the electronic smoke detection unit 130 from the atmosphere. In some embodiments, seal-tightness can be ensured in other ways. For example, in another embodiment, this set of electronic elements is coated with a resin to isolate these electronic elements from the atmosphere. In an example of realization, the thickness of the resin on the component that extends farthest from the electronic circuit is at least 30 mm.

The first light guide 141 and the second light guide 142 are arranged to enter the electronics compartment 120 in a way that is seal-tight to the atmosphere. In this way, the exposure of electronic elements of the electronic smoke detection unit 130 to the atmosphere is avoided. Seal-tightness around the light guides when they enter the electronics compartment can be ensured in various ways. For example, in this first embodiment, the optical detector 100 comprises O-rings 151 and 152 to ensure seal-tightness between the first and second light guides, 141 and 142, and the electronics compartment 120, respectively where the first and second light guides, 141 and 142, enter the seal-tight casing 125.

In some embodiments, seal-tightness is ensured by directly molding light guides 141, 142 in a resin for encapsulating the electronic elements and, preferably, metal parts of the electronics compartment 120. In a particular embodiment of the invention, one end of each light guide 141 and 142 is buried in the resin.

In the first embodiment shown in FIG. 1, the first light guide 141 and the second light guide 142 are each surrounded by a sleeve whose refractive index is lower than the refractive index of the light guide. In this way, a light ray that enters a light guide at a suitable angle undergoes multiple internal reflections. Thus, if the material forming the core of the light guide is not too absorbent for the light transmitted, the light that enters at one end of the light guide 141, 142 is almost entirely retrieved at the other end of the light guide 141, 142. In some embodiments, at least one of the light guides 141, 142 is surrounded by a light-reflecting layer.

The electronic detection unit 130 comprises supply and signal processing components for, firstly, supplying electricity to the emitter 131 and the receiver 132 and, secondly, processing the electrical signals output from the light receiver component 132 to determine whether smoke is traversing the detecting zone D. These components and their connection are known to the person skilled in the art of smoke detectors and thus they are not described any further here.

The light guides 141 and 142 are oriented relative to each other in such a way that, if there is no smoke in the detecting zone D, the light emitted by the emitter 131 does not reach the receiver 132. When smoke particles enter the measurement chamber 110 and reach the detecting zone D, light is directed by smoke particles to the light guide 142, which directs it to the receiver 132. When the electronics for processing detection signals 133 detects that the amount of light received by the receiver 132 exceeds a predefined limit value, an alarm signal is triggered in an alarm module to indicate the presence of smoke.

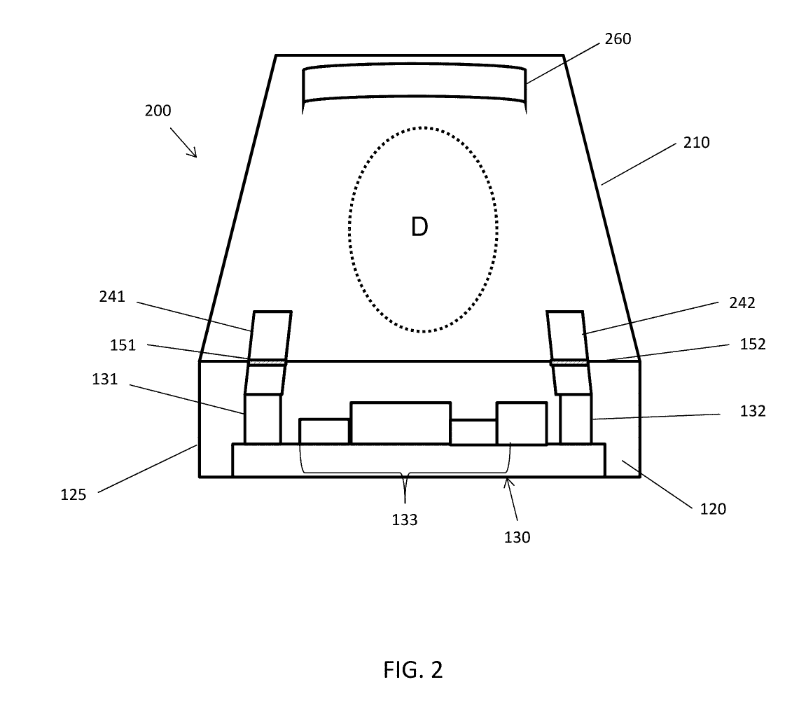

In a second embodiment of the invention shown in FIG. 2, the optical detector 200 also comprises a reflector 260 to direct light emitted by the emitter 131 to the receiver 132 if there is no smoke in the detecting zone D. When particles, for example smoke particles, enter a measurement chamber 210 and reach the detecting zone D, light is scattered or absorbed by these particles such that the amount of light directed by the first light guide 241 to the second light guide 242 is decreased. When the electronics for processing detection signals 133 detects that the amount of light received by the receiver 132 is below a predefined limit value, an alarm signal is triggered in an alarm module to indicate the presence of smoke.

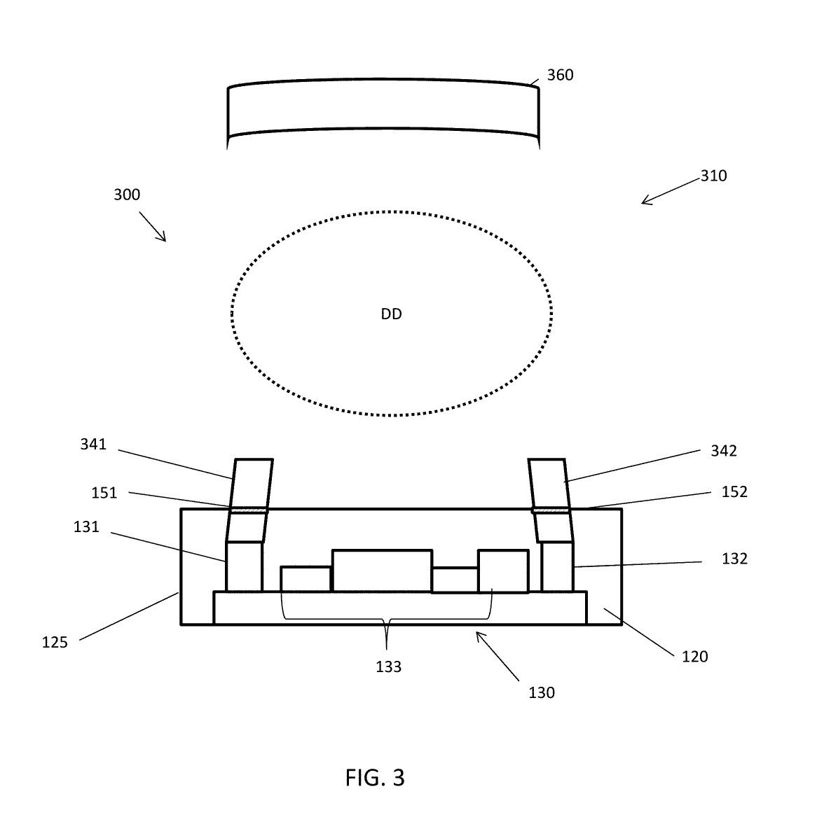

An optical detector of an atmospheric physical quantity value representative of a danger according to a third embodiment is represented schematically in FIG. 3. In this embodiment, the optical detector 300 is configured to detect the presence of smoke in the atmosphere, the value of the physical quantity representative of a danger being the amount or level of smoke particles or aerosols, associated to a fire, in the atmosphere. FIG. 3 shows an optical detector 300 comprising an electronics compartment 120, similar to the electronics compartment 120 of the first embodiment, for receiving an electronic smoke detection unit 130. The electronic smoke detection unit 130 comprises a light emitter 131, a light receiver 132 that is sensitive to at least one portion of the wavelengths of the light rays emitted by the emitter 131, and electronics for processing detection signals 133.

In this third embodiment of the invention, the measurement chamber consists of a zone 310 of the premises to be monitored, in which the optical detector 300 is installed. A reflector 360 is installed in the premises to direct, by reflection, light emitted by the emitter 131 to the receiver 132 if there is no smoke in a detecting zone DD of the zone 310 of the premises.

When smoke particles enter the zone 310 of the premises and reach the detecting zone DD, light is scattered by the smoke particles such that the amount of light directed by the first light guide 341 to the second light guide 342 is decreased. When the electronics for processing detection signals 133 detects that the amount of light received by the receiver 132 is below a predefined limit value, an alarm signal is triggered in an alarm module to indicate the presence of smoke.

An alarm system 1055 according to an embodiment of the invention is shown in FIG. 10. The alarm system 1055 comprises an alarm device 1020 and optical detectors 1005 according to one of the embodiments of the invention. Each optical detector 1005 is connected to the alarm device by a link 1045, wired or not, for transmitting detection signals to the alarm device. The alarm device 1020 comprises an emitter of alarm signals 1050, where the emission of alarm signals is representative of the detection by at least one of the optical detectors 1005 of an atmospheric physical quantity value representative of a danger. The alarm device 1020 comprises, for example, a loudspeaker 1050.

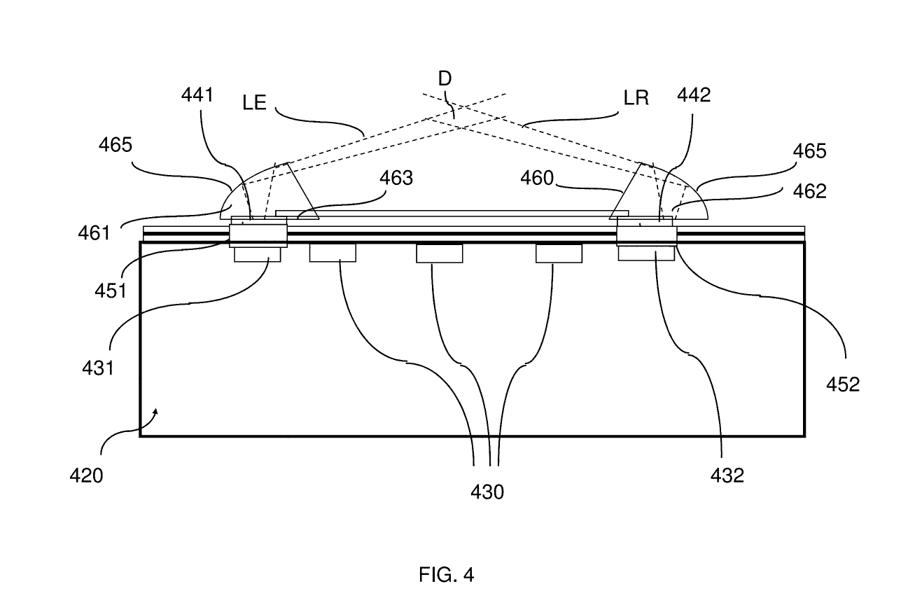

In a fourth embodiment shown in FIG. 4, the first light guide and the second light guide have light reflectors on the measurement zone side, formed here of the surfaces 465 of two prisms, respectively 461 and 462.

The prism 461 facing the emitter 431 is arranged to direct the light LE emitted by the emitter 431 to a detecting zone D. The prism 462 facing the receiver 432 is arranged to direct, in the presence of smoke in the detecting zone D, the scattered light LR originating from said detecting zone D to the receiver 432. The intersection of the light cone emitted from the first light guide 461 and the usable reception cone of the second light guide 462 defines the detecting zone D.

The light rays LE and LR, usable for detecting smoke, and the detecting zone D are shown by dashed lines in FIG. 4. Each of prisms 461 and 462 has a flat lower surface 463, an oblique flat side surface 460 and a curved surface 465 forming a convergent mirror.

Prisms 461 and 462 are, for example, made of polycarbonate. This material has the advantage of being, at least partially, transparent in part of the infrared spectrum. Thus, the receiver is not sensitive to ambient light, which reduces the risks of a false alarm. The transmission of light rays is facilitated both in the prism on the light emitter side and in the prism on the light receiver side. In addition, this material exhibits limited retraction during demolding of molded parts.

As shown in FIG. 4, the shape of the curved surface 465 of prisms 461 and 462 and the angle of incidence of the light rays LE and LR on this curved surface 465 make it a convergent mirror whose focal length is substantially equal to the distance traveled by the central light rays emitted by the light emitter 431 before reaching the curved surface 465, multiplied by the optical index of the material the prism is made of. In this way, the light rays output from the prism facing the light emitter component 431 are practically parallel.

For reasons of symmetry, the light rays from the detecting zone D converge, thanks to the curved surface 465 of the prism facing the light receiver component 432, on the sensitive portion of this receiver 432.

The electronic detection unit including the emitter and the receiver is housed in an electronics compartment seal-tight to the atmosphere.

The first light guide 441 and the second light guide 442 are arranged to enter the electronics compartment 420 that houses the electronic detection unit in a way that is seal-tight to the atmosphere to avoid the exposure of electronic elements 430 to the atmosphere. Seal-tightness around the light guides when they enter the electronics compartment can be ensured in various ways. For example, in this fourth embodiment, the optical detector 400 comprises O-rings 451 and 452 to respectively connect the first and second light guides, 441 and 442, to the electronics compartment 420, where the first and second light guides, 441 and 442, enter the seal-tight casing 425.

In some embodiments, seal-tightness is ensured by directly molding light guides 441, 442 in a resin for encapsulating the electronic elements and, preferably, metal parts of the electronics compartment. In a particular embodiment of the invention, one end of each light guide 441 and 442 is buried in the resin.

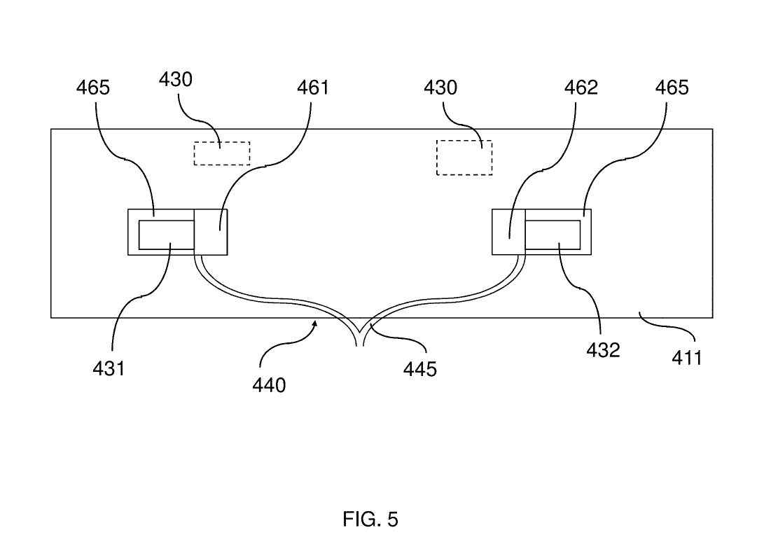

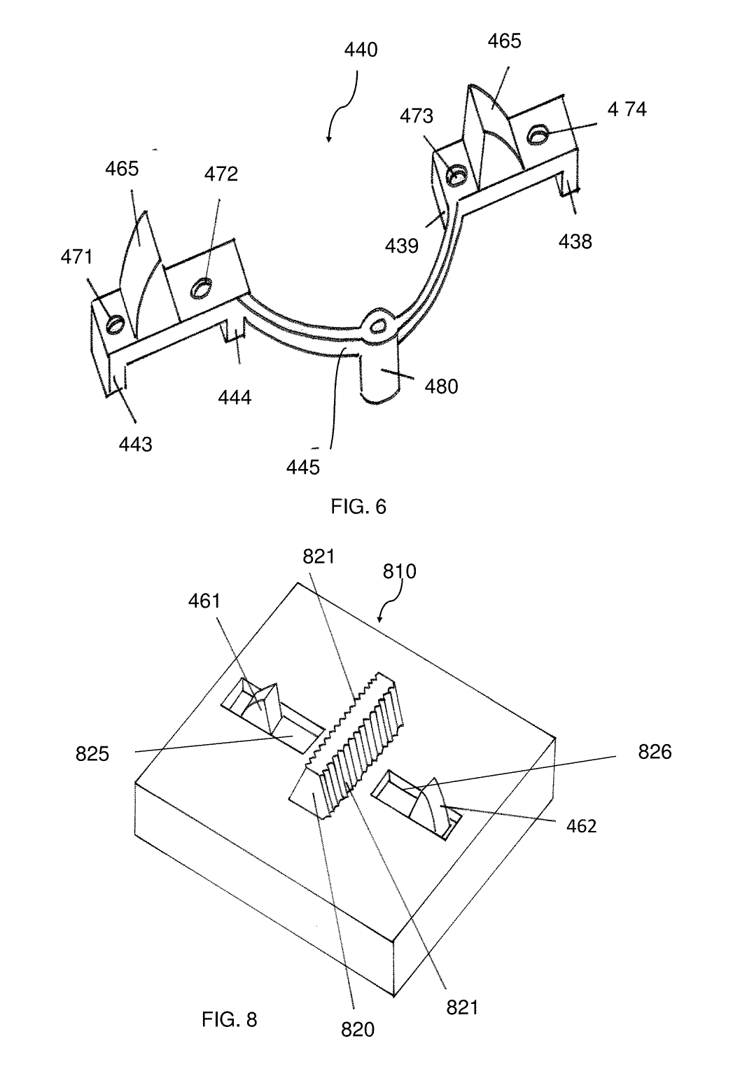

As shown in FIG. 5 and FIG. 6, the prisms 461 and 462 form, in a particular embodiment, a single mechanical part 440, with a link 445 connecting prisms 461 and 462 within this single part 440.

In some particular embodiments, this link comprises an optical guide that carries a portion of the light emitted by the emitter 431 to the receiver 432, the electronic smoke detection unit 430 being designed to detect the absence of reception, by said receiver 432, of said portion of the light emitted by the emitter 431, and to emit a signal representative of this absence of reception. Thus, a very small portion of the light emitted by the emitter 431 arrives continuously at the receiver 432. When it is detected that the receiver 432 is no longer emitting a signal representative of this portion or is emitting an attenuated signal, the electronic detection unit 430 signals a fault or malfunction of the optical detector 400. The portion of the light that arrives continuously is calibrated (by means of the geometry of the mechanical part) to always be less than the level of light required for detecting smoke, so that this permanent portion does not disrupt the detection of smoke, and to generate a signal greater than the thermal noise, at the output from the receiver 432.

Measuring the amount of light arriving continuously at the receiver 432 thus allows the aging, or fault, of the emitter 431 and/or the receiver 432 to be measured. The aging or fault preferably causes a signal to be emitted, light, sound or to a central system, representative of the problem and of the need to carry out repair or maintenance operations on the smoke detector.

In some embodiments, the mechanical link 440 forms a split optical guide 480, as shown in FIG. 6, to prevent the parasitic light from the emitter component 431 reaching, by means of it, the receiver component 432. In some embodiments, the first light reflector formed by a surface 465 of prism 461 is connected to the second light reflector, formed by a surface 465 of prism 462, by means of a link resistant to the passage of parasitic light, to form a single mechanical part 445. For example, the material forming the single part is not, between the prisms, transparent to the wavelengths emitted by the light emitter.

In some embodiments, the link between prisms 461 and 462 is formed of any other means arranged so as to prevent parasitic light passing from the emitter to the receiver. For example, the link can be formed by an optical guide comprising a central zone in the form of a chicane, a zone absorbing light in the wavelengths of the light rays emitted by the emitter and/or a zone reflecting light in the wavelengths of the light rays emitted by the emitter.

The mechanical part 445 can, advantageously, be obtained by injecting polymer, eg polycarbonate, into a mold by positioning in the injection tool the hole through which the molten material enters the mold in the area corresponding to the central zone of the split optical guide 480. This makes it possible to use the injection sprue, formed by the material having filled the feed channel between the nose of the injection cylinder and the mold inlet, to produce the optical guide and thus to save material and avoid an additional operation, i.e. extracting the sprue, when the injected parts are retrieved. These injection techniques are known to the person skilled in the art of working polymers and thus they are not described any further here.

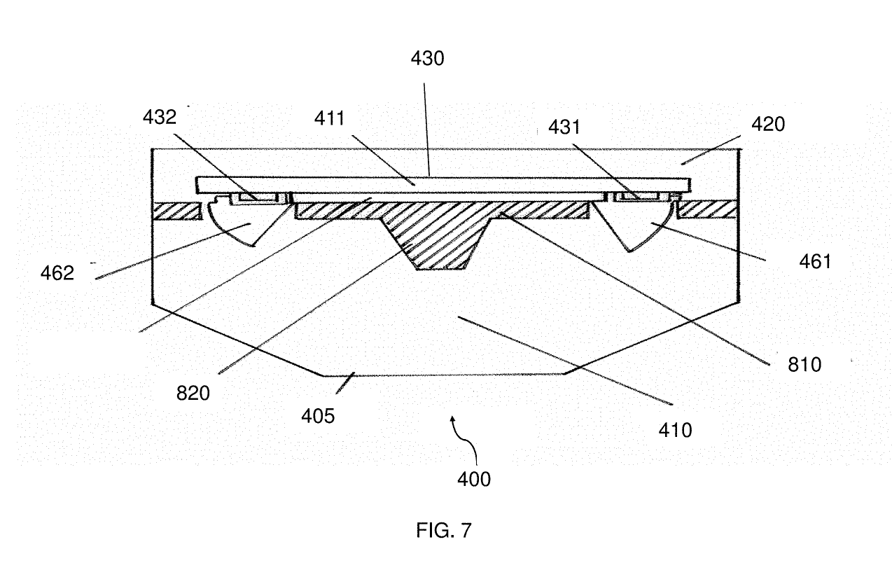

As shown in FIG. 7, in this embodiment of the invention a smoke detector 400 comprises a casing 405 comprising two separate zones: the measurement chamber 410, which contains the detecting zone D accessible to smoke particles, and the electronics compartment 420, which houses the electronic smoke detection unit 430. The casing 405 has openings in chicanes to allow air to pass through the detecting zone D while minimizing the penetration of ambient light into the detecting zone D. The internal walls of the casing are arranged to reflect the light rays as little as possible. As shown in FIG. 8, the surface of the seal-tight casing 425 of the electronics compartment 420 on the measurement chamber 410 side is equipped with an optical wall 820 which, if there is no smoke in the detecting zone D, prevents the light emitted by the emitter 431 to the detecting zone D via prism 461 from reaching the receiver 432 via prism 462. The optical wall 820 has two opposite surfaces 821 that are crenelated to reflect the light rays as little as possible.

The prism 461 facing the emitter 431 is positioned on one of the sides of the wall 820 and the prism 462 facing the receiver 432 is placed on the other side of the wall 820 such that the light rays cannot circulate directly from one prism to the other. The prism 461 facing the emitter 431 focuses the light in the detecting zone D. When smoke particles are present in the detecting zone D, the light is scattered towards the prism 462 facing the receiver 432, which collects it and sends it to the receiver 432.

In the embodiment shown in FIGS. 6 to 8, the mechanical part 445 comprising the two prisms 461, 462 is mounted on a printed circuit 411 such that the configuration of prism 461 in relation to prism 462 is fixed. The mechanical part 445 is equipped with a device for precise positioning relative to an intermediate mount 810, fixed to the surface of the casing 425, namely centering studs (not shown) designed to cooperate with holes located on the intermediate mount 810, holes 471, 472, 473 and 474 designed to cooperate with pins located on the intermediate mount 810, or clips located on the intermediate mount 810. The positioning of the prisms is thus easily reproducible. This makes it possible to reproduce the emission/reception angles of the light rays.

Two openings 825, 826 in the surface of the mount 810 allow the two prisms 461, 462 to be positioned in the measurement chamber, the split optical guide 480 between the two prisms being positioned on the other side of the mount. The mount 810 is arranged to prevent the parasitic light passing to the scattering zone, except through the prisms 461, 462.

On the surface located on the printed circuit side, it can be advantageous to equip prisms 461 and 462 with two flat undercuts so as to allow the emitter 431 and receiver 432 to be positioned inside these undercuts, so that the prisms can come into contact with the printed circuit.

In a variant, the prisms and/or the mechanical part come into contact with the printed circuit by avoiding the above undercuts, through the provision of stops 443, 444, 438 and 439.

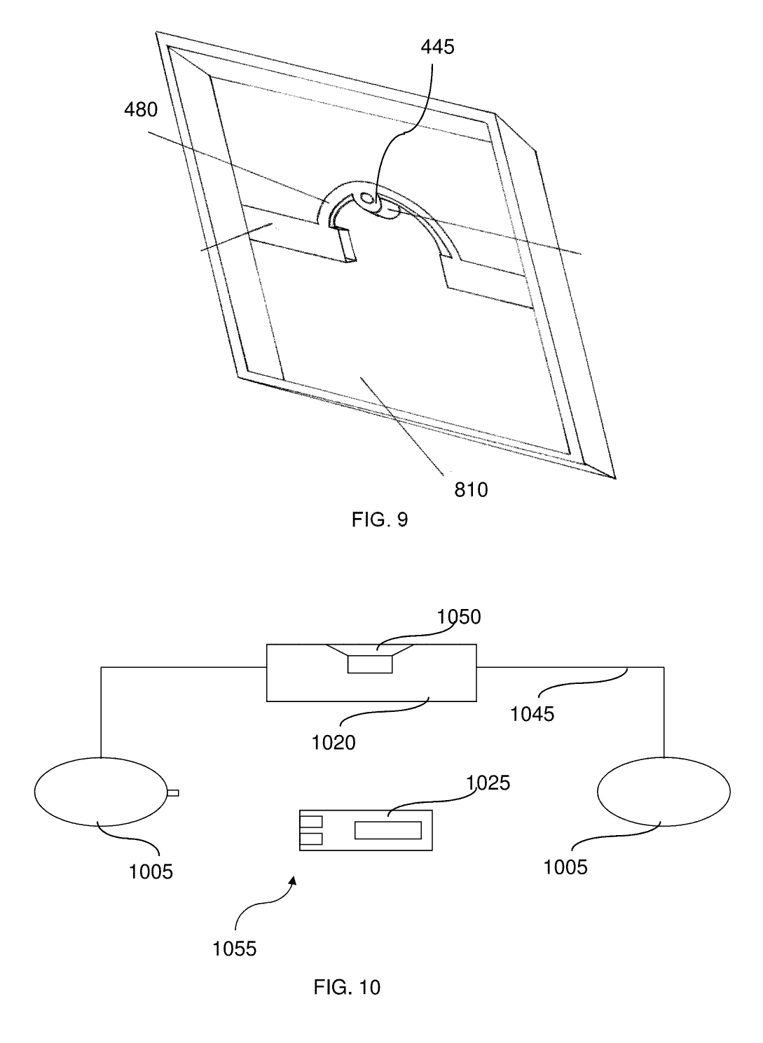

In the embodiment shown in FIG. 9, the printed circuit 411 is fixed to the intermediate mount 810 by clips located, for example, on the periphery of this intermediate mount 810. In this way the optical prisms are precisely positioned with regard to the intermediate mount 810, which is itself precisely positioned with regard to the printed circuit 411. It is thus easy to reproduce the positioning of the prisms over a series of printed circuits.

In the embodiment shown in FIG. 5, the link 445 takes the form of an optical fiber that emerges on the outside of the electronic smoke detection circuit.

In this way, it is possible to:
check the operation of the emitter component by positioning an external receiver component, for example in a movable casing 1025 opposite the place where the optical fiber 1045 emerges;
especially in the case where the emitter component is likely to emit in the visible spectrum, communicate at least one item of information to the outside such as, for example, signal a detection of smoke or a failure of the smoke detector circuit visually or by means of a movable casing 1025; and/or
communicate with the smoke detection circuit by emitting, for example with a remote control 1025 shown in FIG. 10, a light signal to the place where the optical fiber emerges.

1. Optical detector of a value of an atmospheric physical quantity representative of a danger, the detector comprising:
at least one measurement chamber accessible to the atmosphere; and
at least one electronics compartment for receiving an electronic device for detecting the value of the atmospheric physical quantity representative of a danger, the electronic detection device comprising at least
one light emitter;
one light receiver that is sensitive to at least one portion of the wavelengths of the light rays emitted by the emitter; and
electronics for processing detection signals;
a first light guide facing the emitter in order to direct the light emitted by the emitter from the electronics compartment comprising said emitter to a detecting zone in a measurement chamber; and
a second light guide facing the light receiver of said electronics compartment, in order to direct light originating from said detecting zone to the electronics compartment in order to be received by the receiver, the amount of light received by the receiver being representative of the value of the physical-quantity representative of a danger;
wherein the electronics compartment is separated from the measurement chamber and isolates all the electronic elements it contains from the atmosphere; and the light guides are arranged to enter the electronics compartment in a way that is seal-tight to the atmosphere.

2. Optical detector according to claim 1, wherein, for at least one electronic device, the first and second light guides consist of a single part comprising a link resistant to the passage of the light from the first light guide to the second light guide.

3. Optical detector according to claim 2, wherein the link resistant to the passage of the light bears a centering stud.

4. Optical detector according to claim 2, wherein said link comprises an optical guide designed to carry a portion of the light emitted by the emitter to the receiver, the electronic smoke detection unit being designed to detect the absence of reception, by said receiver, of said portion of the light emitted by the emitter.

5. Optical detector according to claim 2, wherein the link resistant to the passage of the light is a split optical guide, a portion of the split optical guide emerging at the exterior of the optical detector in a way that is seal-tight to the atmosphere.

6. Optical detector according to claim 2, wherein the link resistant to the passage of the light is an optical guide forming a chicane, one optical guide comprising a zone absorbing light in the wavelengths of the light rays emitted by the emitter and/or one optical guide comprising a zone reflecting light in the wavelengths of the light rays emitted by the emitter.

7-25. (canceled)

26. Optical detector according to claim 1, wherein the electronics compartment isolates all the electronic elements from the atmosphere by coating all the electronic elements it contains with an electrically insulating resin.

27. Optical detector according to claim 1, wherein seal-tightness is ensured by directly molding light guides in a resin for encapsulating the electronic elements and metal parts of the electronics compartment.

28. Optical detector according to claim 1, wherein at least one emitter emits light rays with wavelengths in the infrared spectrum, and each light guide comprises at least one portion made of silica or polycarbonate.

29. Detector according to claim 1, wherein said value of the physical-quantity in the detecting zone corresponds to the scattering of the light emitted by the emitter to the receiver.

30. Optical detector according to claim 1, wherein said value of the physical-quantity in the detecting zone corresponds to the reduction, by absorption, of the light directed from the emitter to the receiver.

31. Optical detector according to claim 30, that comprises at least one reflector for reflecting the light originating from the first light guide, in the measurement chamber, to the second light guide.

32. Optical detector according to claim 1, wherein the first light reflector comprises a convergent reflector arranged to focus the light in the detecting zone, and/or the second light reflector comprises a convergent reflector arranged to focus the light originating from the detecting zone onto the receiver.

33. Optical detector according to claim 1, that also comprises:
a casing for housing the measurement chamber and arranged to allow air to pass while minimizing the introduction of parasitic light into said measurement chamber; and
an intermediate mount placed in the casing, equipped with an optical wall arranged to prevent the light emitted by the light guide located on the emitter side from reaching the light guide located on the receiver side.

34. Optical detector according to claim 1, wherein at least one of the light guides has one end placed in the measurement chamber and comprising a cylindrical portion extending up to and including the traversal of the seal-tight casing.

35. Optical detector according to claim 34, wherein the end positioned in the measurement chamber has the shape of a lens enabling the light beam that comes from it to be shaped.

36. Optical detector according to claim 34, wherein the end positioned in the measurement chamber has the shape of an optical prism.

37. Optical detector according to claim 1, that also comprises a reflector for the light waves emitted by a first light guide, this reflector being positioned to send said light beam back to a second light guide.

38. Optical detector according to claim 37, wherein the measurement chamber consists of the premises to be monitored, the optical detector being placed in the vicinity of a first extremity of the premises, the light beam emitted through the first light guide traversing said premises, the reflector being placed in the vicinity of the opposite extremity of said premises, and being positioned to send said light beam back to the second light guide.

39. Alarm device comprising at least one detector according to claim 1, and an emitter of alarm signals, wherein the emission of alarm signals is representative of the detection by an optical detector of a value of the physical quantity representative of a danger.
